(19) United States
(12) Patent Application Publication
(10) Pub. No.: US 2026/0348428 A1
(43) Pub. Date: Nov. 5, 2026

(54) VEHICULAR WHEEL BEARING

(71) Applicant: ILJIN GLOBAL CO.,LTD, Seoul (KR)

(72) Inventors: Jin Hyeok CHOI, Seoul (KR); In Ha LEE, Seoul (KR); Jung Ho AN, Seoul (KR); Yeon Sik LEE, Seoul (KR)

(73) Assignee: ILJIN GLOBAL CO.,LTD, Seoul (KR)

(21) Appl. No.: 19/558,926

(22) Filed: Mar. 6, 2026

(30) Foreign Application Priority Data
Mar. 7, 2025 (KR) 10-2025-0029545

(51) Int. Cl. F16C 19/18

(52) U.S. Cl. CPC F16C 19/184; F16C 2226/80; F16C 2326/02

(57) ABSTRACT

A vehicular wheel bearing includes a wheel hub on which the vehicle wheel is mounted and which rotates together with the vehicle wheel; at least one inner ring mounted to the wheel hub; an outer ring fixedly coupled to a vehicle-body-side member; and a plurality of rolling elements configured to rotatably support the wheel hub and the inner ring relative to the outer ring. A face-spline portion is provided on an axially inner end surface of the wheel hub or the inner ring and may be configured to receive driving power from a constant velocity joint. The face-spline portion may be configured such that tooth crests and tooth roots are alternately and repeatedly arranged along a circumferential direction, and each tooth crest of the face-spline portion is formed to have a fully rounded shape only in a first region including a highest crest portion having a maximum crest height.

### CROSS-REFERENCE TO RELATED APPLICATION

This application claims priority to Korean Patent Application No. 10-2025-0029545 filed on Mar. 7, 2025, the entire contents of which are herein incorporated by reference.

### TECHNICAL FIELD

The present disclosure relates to a vehicular wheel bearing for rotatably mounti and supporting a vehicle wheel on a vehicle body, and more particularly, to a vehicular wheel bearing configured to transmit driving power through face-splines formed on an axial end surface.

### DESCRIPTION OF THE RELATED ART

A wheel bearing is a device for rotatably mounting and supporting a vehicle wheel to a vehicle body, and may be classified into a drive-wheel wheel bearing used for a drive wheel of a vehicle and a driven-wheel wheel bearing used for a driven wheel of a vehicle.

Referring to FIG. 1, a structure of a conventional drive-wheel wheel bearing is illustratively shown.

As shown in FIG. 1, a wheel bearing 10 is configured such that a rotating element (for example, a wheel hub 20 and an inner ring 30) to which a wheel is mounted is connected to a non-rotating element (for example, an outer ring 40) fixed to a vehicle body through rolling elements 50, thereby rotatably supporting the vehicle wheel with respect to the vehicle body. A constant velocity joint 60 is coupled to one side of the wheel bearing 10 so as to transmit driving power generated by a drive device to the wheel bearing 10.

Meanwhile, the constant velocity joint 60 may be formed in a structure in which rolling members 80 and an inner member supporting the rolling members are accommodated in an outer member 70, and a central shaft 90 connected to the drive device is coupled to the inner member. A stem portion 75 extending in an axial direction is formed at an axially outer end of the outer member 70, and splines formed on an outer circumferential surface of the stem portion 75 are configured to be engaged with splines formed on an inner circumferential surface of the wheel hub 20.

However, since the wheel bearing 10 having such a structure is configured to transmit driving power by engagement between axial splines formed on the stem portion 75 of the constant velocity joint 60 and axial splines formed on the wheel hub 20, it is necessary to form the stem portion 75 having a relatively long length extending through the wheel hub 20 to the constant velocity joint 60. As a result, the weight of the wheel bearing assembly may increase, and noise or vibration may occur due to slipping generated when an axially inner end surface of the wheel hub 20 comes into contact with an axially outer end surface of the outer member 70 of the constant velocity joint 60.

As a measure to address such problems, there has been proposed a vehicular wheel bearing configured to transmit driving power through engagement of face-splines formed on axial end surfaces of a rotating element of a wheel bearing (for example, a wheel hub, an inner ring, etc.) and a constant velocity joint.

However, in conventional face-spline wheel bearings, tooth crests of the face-spline are formed in a straight planar shape. Accordingly, when assembling the face-splines formed on the wheel bearing and the constant velocity joint, the tooth crests of one face-splines may fail to be accurately engaged with the tooth roots of the other face-splines, resulting in crest-to-crest interference. Consequently, there is a risk of reduced driving power transmission capability due to unstable engagement of the face-splines and damage to the teeth caused by such unstable engagement of the face-splines.

### DISCLOSURE OF THE INVENTION

### Technical Goals

The present disclosure is for the purpose of providing a vehiclular wheel bearing configured to transmit driving power through face-splines formed on axial end surfaces of a wheel bearing and a constant velocity joint, in which a tooth profile structure of the face-splines is improved so as to secure stable engagement between the face-splines and to provide enhanced manufacturability by preventing damage to a tool used to form the face-splines.

### Technical Solutions

Representative configurations of the present disclosure to achieve the above-described purpose are as follows.

According to an embodiment of the present disclosure, a vehicular wheel bearing for rotatably mounting and supporting a vehicle wheel to a vehicle body may be provided. The vehicular wheel bearing according to an embodiment of the present disclosure may comprise: a wheel hub on which the vehicle wheel is mounted and which rotates together with the vehicle wheel; at least one inner ring mounted to the wheel hub; an outer ring fixedly coupled to a vehicle-body-side member; and a plurality of rolling elements configured to rotatably support the wheel hub and the inner ring relative to the outer ring. According to an embodiment of the present disclosure, a face-spline portion may be provided on an axially inner end surface of the wheel hub or the inner ring to receive driving power from a constant velocity joint. According to an embodiment of the present disclosure, the face-spline portion may be configured such that tooth crests and tooth roots are alternately and repeatedly arranged along a circumferential direction, and each tooth crest of the face-spline portion may be formed to have a fully rounded shape only in a first region including a highest crest portion having a maximum crest height.

According to an embodiment of the present disclosure, each tooth crest of the face-spline portion may be formed in a shape other than a fully rounded shape in a second region positioned radially inward relative to the first region.

According to an embodiment of the present disclosure, the face-spline portion may be formed in a structure in which, as moving radially inward from the highest crest portion, a height of the tooth crest decreases and a width between adjacent tooth roots becomes narrower.

According to an embodiment of the present disclosure, in the second region, the tooth crest may be configured to gradually change from a fully rounded shape to a straight planar shape as moving radially inward.

According to an embodiment of the present disclosure, when viewed in a longitudinal cross-section taken along an axial direction, a ridge of the tooth crest of the face-spline portion may be formed in a convex curved shape.

According to an embodiment of the present disclosure, in the face-spline portion, an outer end of a flank surface of each tooth may be formed in a convex curved shape.

According to an embodiment of the present disclosure, a radially outer end of the face-spline portion may be formed in a convex curved surface shape.

According to an embodiment of the present disclosure, the face-spline portion may be configured to be formed on an axially inner end surface of the wheel hub.

According to an embodiment of the present disclosure, the inner ring may be configured to be fixed on the wheel hub by a forming portion formed by plastically deforming an axially inner end of the wheel hub radially outward, and the face-spline portion may be configured to be formed on an axially inner end surface of the forming portion of the wheel hub.

According to an embodiment of the present disclosure, the face-spline portion may be configured to be formed on an axially inner end surface of the inner ring.

In addition, the vehicular wheel bearing according to the present disclosure may further comprise other additional components to the extent that it does not impair the technical idea of the present disclosure.

### Effects

In the vehicular wheel bearing according to an embodiment of the present disclosure, each tooth crest of the face-spline portion is formed to have a fully rounded shape in a partial region, thereby enabling more stable teeth engagement as compared with conventional face-splines having a straight tooth crest structure. Accordingly, stable driving power transmission may be secured and damage to the teeth may be prevented.

Further, in the vehicular wheel bearing according to an embodiment of the present disclosure, the tooth crest of the face-spline portion is formed in a fully rounded shape only in a partial region including the highest crest portion. Accordingly, as compared with a case in which the entire tooth crest is formed in a rounded shape, damage to a tooth-forming tool may be prevented, and thus manufacturability of the face-spline wheel bearing may be further improved.

### BRIEF DESCRIPTION OF THE DRAWINGS

FIG. 1 illustratively shows a structure of a conventional vehicular wheel bearing (drive-wheel wheel bearing).

FIG. 2 illustratively shows a vehicular wheel bearing according to an embodiment of the present disclosure.

FIG. 3 illustratively shows a cross-sectional structure of the vehicular wheel bearing according to an embodiment of the present disclosure.

FIG. 4 illustratively shows a shape of a face-spline portion of the vehicular wheel bearing according to an embodiment of the present disclosure.

FIG. 5 illustratively shows a shape of a starting point of a tooth crest of teeth of the face-spline portion of the vehicular wheel bearing according to an embodiment of the present disclosure.

FIGS. 6A, 6B, and 6C illustratively show cross-sectional shapes of teeth of the face-spline portion of the vehicular wheel bearing according to an embodiment of the present disclosure.

FIG. 6A shows a cross-sectional shape of the teeth of the face-spline portion as viewed in a longitudinal cross-section taken along an axial direction (a cross-sectional shape taken along line A-A′ of FIG. 4); FIG. 6B shows a cross-sectional shape of the teeth as viewed in a plane perpendicular to a radial direction at a highest crest portion (a cross-sectional shape taken along line B-B′ of FIG. 4); and FIG. 6C shows a cross-sectional shape of the teeth as viewed in a plane perpendicular to the radial direction at a radially inner position relative to the highest crest portion (a cross-sectional shape taken along line C-C′ of FIG. 4).]

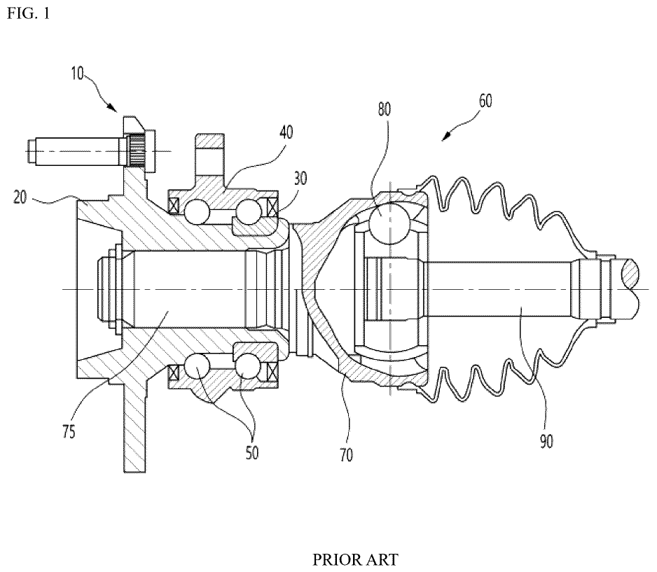

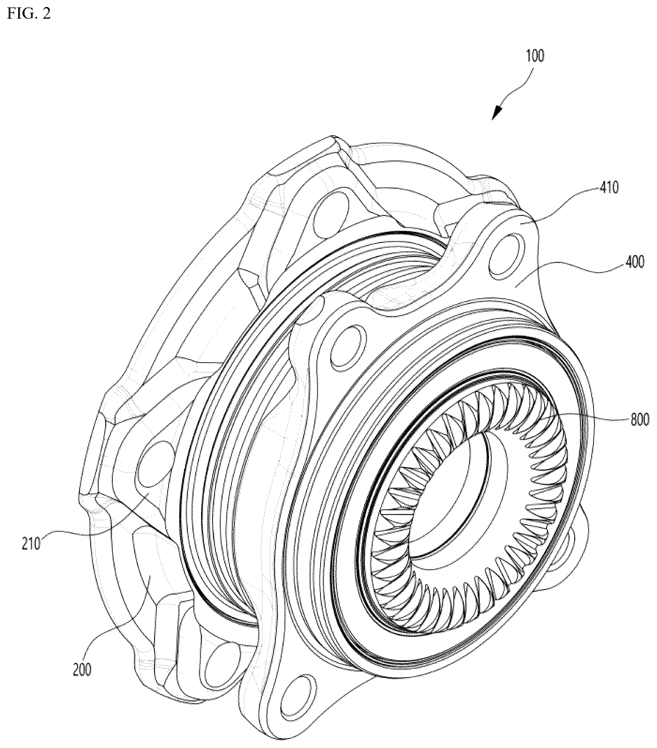

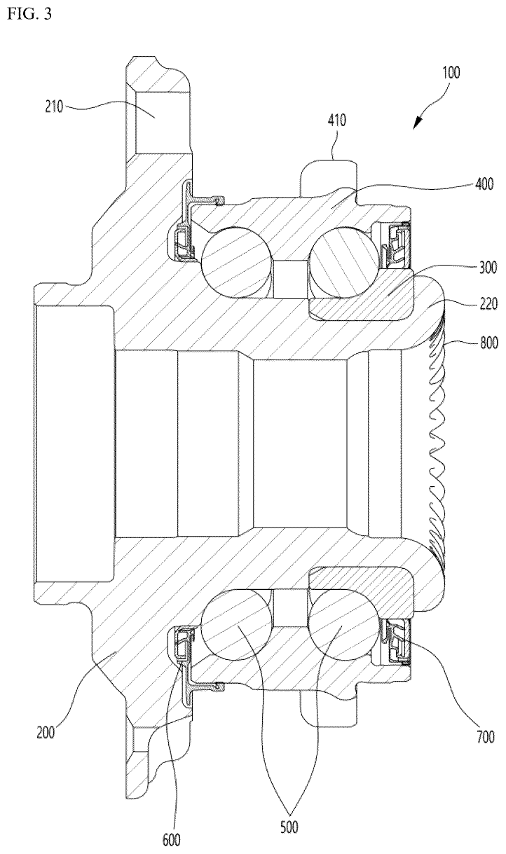

### DETAILED DESCRIPTION

Example embodiments of the present disclosure described herein are exemplified for the purpose of describing the technical spirit of the present disclosure. The scope of the claims according to the present disclosure is not limited to the example embodiments described below or to detailed descriptions of these example embodiments.

Unless otherwise defined, all technical and scientific terms used herein have the same meaning commonly understood by those skilled in the art to which the present disclosure pertains. All terms used herein are selected for the purpose of more clearly describing the present disclosure and not limiting the scope of the present disclosure defined by appended claims.

Unless the phrase or sentence clearly indicates otherwise, terms “comprising,” “including,” “having,” and the like used herein should be construed as open-ended terms encompassing the possibility of including other example embodiments.

The term “axial direction” used herein may be defined as a direction extending along a rotational central axis of a wheel bearing, wherein “axially inner” refers to a direction toward a vehicle body, and “axially outer” refers to a direction toward a wheel. The term “radial direction” used herein may be defined as a direction perpendicular to the axial direction and away from the rotational central axis or approaching the rotational central axis. The term “circumferential direction” used herein may be defined as a direction rotating about the axial direction described above.

Unless the phrase or sentence clearly indicates otherwise, the expression “a constituent element extends in the axial direction or the radial direction” used herein should be understood as encompassing a case where the constituent element extends parallel to the axial direction or the radial direction as well as a case where the constituent element extends obliquely with respect to the axial direction or the radial direction.

The singular form described herein may include the plural form unless the context clearly dictates otherwise, and this is equally applied to the singular form set forth in the claims.

Throughout the present specification, when a constituent element is referred to as being “positioned” at or “formed” on one side of another constituent element, the constituent element may be in direct contact with or directly formed on the one side of another constituent element, or may be positioned at or formed on another constituent element by intervening yet another constituent element therebetween.

Hereinafter, preferred embodiments of the present disclosure will be described in detail with reference to the accompanying drawings to such an extent that a person having ordinary skill in the art to which the present disclosure pertains can readily practice the present disclosure. In the accompanying drawings, the same reference numerals are assigned to the same or corresponding components. Furthermore, in the following descriptions of the example embodiments, duplicate description(s) of the same or corresponding constituent elements may be omitted. However, even if description(s) of a specific component is omitted in the following description, this is not intended to mean that such component is excluded from the corresponding embodiment.

Referring to the drawings, a vehicular wheel bearing 100 according to an embodiment of the present disclosure is illustratively shown. As shown in the drawings, the vehicular wheel bearing 100 according to the embodiment of the present disclosure may be formed to have an overall structure substantially similar to that of conventional vehicular wheel bearings.

According to an embodiment of the present disclosure, the vehicular wheel bearing 100 may comprise: a wheel hub 200 on which a vehicle wheel is mounted and which rotates together with the vehicle wheel; at least one inner ring 300 mounted to the wheel hub 200; an outer ring 400 fixedly coupled to a vehicle-body-side member; and a plurality of rolling elements 500 configured to rotatably support the wheel hub 200 and the inner ring 300 relative to the outer ring 400.

According to an embodiment of the present disclosure, the wheel hub 200 may be formed in a substantially cylindrical shape extending in an axial direction, and a wheel mounting flange 210 (hub flange) may be provided on an outer circumferential surface of the wheel hub 200. The wheel mounting flange 210 may extend radially outward from the outer circumferential surface of the wheel hub 200 and may be used to mount the vehicle wheel to the wheel hub 200 by means of hub bolts or the like. Meanwhile, the inner ring 300 may be press-fitted and mounted on a vehicle-body-side end of the wheel hub 200, and a raceway (inner raceway) for the rolling elements may be formed on a portion of the outer circumferential surface of the wheel hub 200 to support the rolling elements 500 from a radially inner side.

According to an embodiment of the present disclosure, at least one inner ring 300 may be mounted on the outer circumferential surface of the wheel hub 200, and a raceway (inner raceway) for the rolling elements may be formed on an outer circumferential surface of the inner ring 300 to support the rolling elements 500 from a radially inner side. For example, the inner ring 300 may be coupled to a mounting portion provided near the vehicle-body-side end of the wheel hub 200 and may be fixed on the wheel hub 200 by a forming portion 220 formed by plastically deforming an axially inner end of the wheel hub 200 radially outward.

According to an embodiment of the present disclosure, the outer ring 400 may comprise, on an outer circumferential surface thereof, a vehicle-body-side mounting flange 410 used to mount the wheel bearing 100 to a vehicle-body-side member, and may comprise, on an inner circumferential surface thereof, raceways (outer raceways) with which the rolling elements 500 are in contact. The outer raceways formed on the inner circumferential surface of the outer ring 400 may cooperate with the inner raceways formed on the wheel hub 200 and/or the inner ring 300 to receive and support the rolling elements 500, which serve as rolling members, between the raceways.

According to an embodiment of the present disclosure, the rolling elements 500 may be disposed between a rotating element of the wheel bearing 100 (for example, the wheel hub 200 and/or the inner ring 300) and a non-rotating element (the outer ring 400) of the wheel bearing 100, and may perform a function of rotatably supporting the rotating element of the wheel bearing 100 relative to the non-rotating element of the wheel bearing 100.

According to an embodiment of the present disclosure, sealing members (for example, an outboard-side sealing member 600 and an inboard-side sealing member 700) may be provided at opposite end portions of the wheel bearing 100, and may be configured to prevent foreign substances from being introduced into a bearing space in which the rolling elements 500 are accommodated.

However, the above-described configurations of the vehicular wheel bearing 100 according to an embodiment of the present disclosure are not necessarily limited to the structures shown in the drawings, and may be variously modified into different structures applicable to vehicular wheel bearings.

For example, in the embodiment shown in the drawings, the vehicular wheel bearing 100 is configured such that one raceway for supporting the rolling elements 500 is directly formed on an outer circumferential surface of the wheel hub 200. However, the vehicular wheel bearing 100 according to an embodiment of the present disclosure may be implemented in other modified structures, such as a structure in which two inner rings 300 are mounted on the wheel hub 200 and the rolling elements 500 are supported by the two inner rings 300.

Further, in the embodiment shown in the drawings, the rolling elements 500 configured to rotatably support the rotating element (for example, the wheel hub 200 and/or the inner ring 300) of the wheel bearing 100 relative to the non-rotating element (for example, the outer ring 400) of the wheel bearing 100 are formed in a spherical balls. However, the rolling elements 500 may alternatively be formed in other shapes of rolling members, such as taper rollers.

Meanwhile, according to an embodiment of the present disclosure, a rotating element (for example, the wheel hub 200 or the inner ring 300) of the wheel bearing may be provided with a face-spline portion 800 on an axial end surface thereof, such that the face-spline portion 800 may be configured to engage with a corresponding face-spline portion (not shown) formed on a constant velocity joint 900 to transmit driving power.

For example, in the embodiment shown in the drawings, the vehicular wheel bearing 100 is configured such that the face-spline portion 800 is formed on an axially inner end surface of the forming portion 220 of the wheel hub 200, and the face-spline portion 800 is engaged with the corresponding face-spline formed on an axially outer end surface of a constant velocity joint.

However, in the vehicular wheel bearing 100 according to an embodiment of the present disclosure, the face-spline portion 800 is not necessarily required to be formed on the wheel hub 200 as shown in the drawings, and may alternatively be formed on an axially inner end surface of the inner ring 300 instead of the wheel hub 200.

As described above, since the vehicular wheel bearing 100 according to an embodiment of the present disclosure is configured to transmit driving power through teeth engagement of the face-splines formed on the axial end surfaces of the wheel bearing and the constant velocity joint, it is not necessary to form a long stem portion extending axially from the constant velocity joint to establish an axial spline engagement. Accordingly, the weight of the wheel bearing assembly may be reduced, and noise generated during operation of the wheel bearing may be suppressed.

According to an embodiment of the present disclosure, the face-spline portion 800 may be formed in a structure in which tooth crests 810 and tooth roots 820 are alternately and repeatedly arranged along a circumferential direction, similar to conventional face-spline wheel bearings.

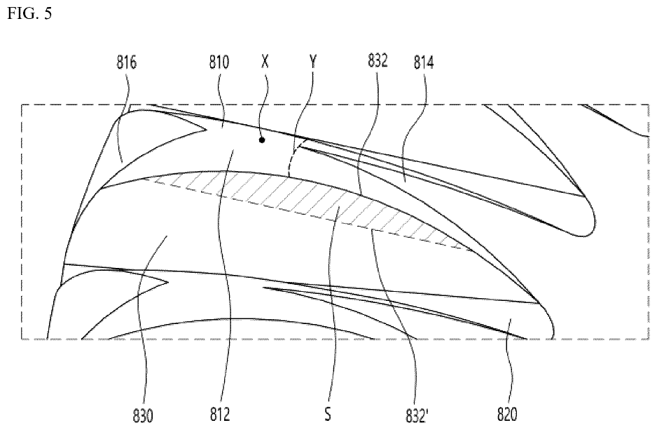

According to an embodiment of the present disclosure, each tooth of the face-spline portion 800 may be formed such that a starting point of the tooth crest, (that is, an outer end 832 of a flank surface 830 of the tooth) has an outwardly convex curved shape (see FIG. 5).

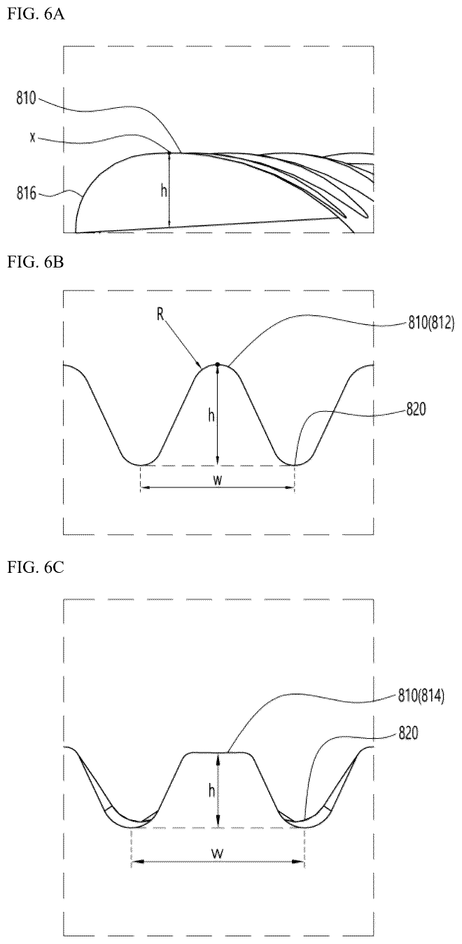

Further, according to an embodiment of the present disclosure, as shown in FIG. 6 A, when viewed in a longitudinal cross-section taken along an axial direction, a ridge of the tooth crest 810 (that is, a line connecting distal ends of the tooth crest 810) may be formed in an outwardly convex curved shape.

In a conventional face-spline portion in which the ridge of the tooth crest is formed in a straight line, a starting point of the tooth crest is formed linearly as indicated by reference numeral 832′ in FIG. 5. In contrast, when the ridge of the tooth crest is formed in a convex curved shape as in the face-spline portion 800 according to an embodiment of the present disclosure, the height of the tooth crest increases, thereby allowing the starting point of the tooth crest to be formed in a convex curved shape as indicated by reference numeral 832 in FIG. 5.

According to such a structure, in the face-spline portion 800 according to an embodiment of the present disclosure, a flank surface area of the tooth may be increased as compared with a conventional structure in which the starting point of the tooth crest is formed linearly (for example, the area may increase by an area S shown in FIG. 5). As a result, a contact area with a corresponding face-spline portion of the constant velocity joint may be increased, thereby further improving driving power transmission capability through the face-spline portions.

According to an embodiment of the present disclosure, the tooth crest 810 of the face-spline portion 800 may be formed to have a fully rounded shape only in a partial region including a highest crest portion X where a height of the tooth crest is greatest.

For example, according to an embodiment of the present disclosure, the tooth crest 810 may be formed to have a fully rounded shape in a first region 812, and to have a shape other than a fully rounded shape in a second region 814 positioned radially inward relative to the first region 812. [In the embodiment shown in FIG. 5, the first region 812 is positioned radially outward with respect to a boundary Y, and the second region 814 is positioned radially inward with respect to the boundary Y.]

According to an embodiment of the present disclosure, the tooth crest 810 of the face-spline portion 800 may alternatively be formed to have a fully rounded shape only at the highest crest portion X where the height of the tooth crest is greatest.

In the present specification, the expression that the tooth crest 810 is formed in a fully rounded shape means that, as shown in FIG. 6B, when viewed in a plane perpendicular to a radial direction, the tooth crest 810 is formed as a single circular arc having a predetermined radius of curvature R so as to be in tangentially contact with both flank surfaces.

According to an embodiment of the present disclosure, the face-spline portion 800 may have a greatest tooth height h (a distance between a distal end of the tooth crest and a distal end of the tooth root) at the highest crest portion X, and the tooth height h may decrease as moving radially inward from the highest crest portion X.

Meanwhile, in the face-spline portion 800 according to an embodiment of the present disclosure, a width w between adjacent tooth roots may decrease as moving radially inward from the highest crest portion X.

According to an embodiment of the present disclosure, in the above-described second region 814, the tooth crest 810 may be configured to gradually change from a fully rounded shape to a straight planar shape as moving radially inward. [For example, at the highest crest portion X, the tooth crest 810 may be formed in a fully rounded shape as shown in FIG. 6B, and as moving radially inward, a radius of curvature of the rounding of the tooth crest 810 may gradually increase, such that the tooth crest 810 is formed in a shape close to a straight line as shown in FIG. 6C.]

As described above, since the vehicular wheel bearing 100 according to an embodiment of the present disclosure is configured such that the face-spline portion 800 is formed in a fully rounded shape only in a partial region including the highest crest portion X, it is possible to prevent damage to a tool caused by the rounded tooth crest during formation of the face-spline. Accordingly, problems such as reduction in tool life and deterioration of manufacturability of the wheel bearing may be prevented.

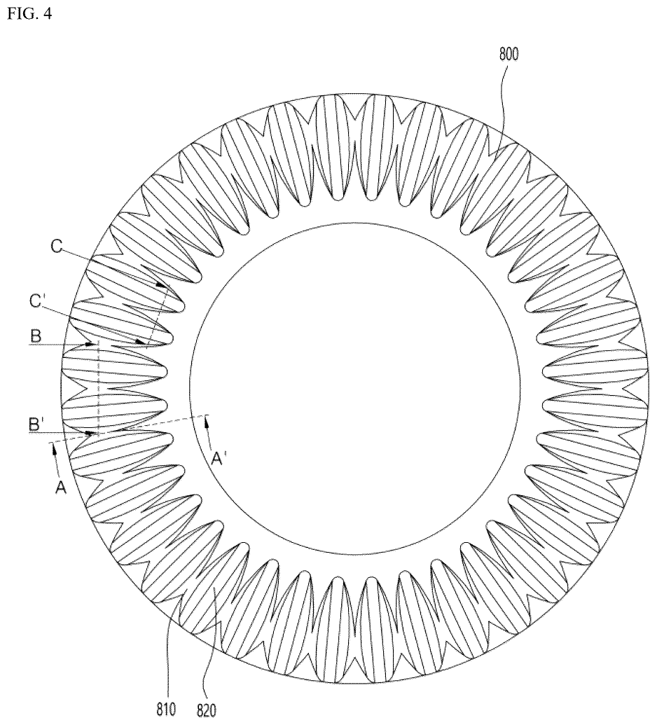

Meanwhile, according to an embodiment of the present disclosure, a radially outer end 816 of the face-spline portion 800 may be formed in a convex curved surface shape, as shown in FIGS. 4 and 6(a).

Although the present disclosure has been described above with reference to specific matters such as particular constituent elements and limited embodiments, these embodiments are provided only to assist in a more comprehensive understanding of the present disclosure, and the present disclosure is not limited thereto. Rather, various modifications and variations may be made from such descriptions by a person having ordinary skill in the art to which the present disclosure pertains.

Accordingly, the spirit of the present disclosure should not be construed as being limited to the embodiments described above, and not only the claims set forth below but also all modifications and variations that are equivalent or substantially equivalent to the scope of the claims should be understood as falling within the scope of the spirit of the present disclosure.

### EXPLANATION OF REFERENCE NUMERALS

100: vehicular wheel bearing
200: wheel hub
210: wheel mounting flange
220: forming portion
300: inner ring
400: outer ring
410: vehicle-body-side mounting flange
500: rolling element
600: outboard-side sealing member
700: inboard-side sealing member
800: face-splines
810: tooth crest (of the face-splines)
820: tooth root (of the face-splines)
X: highest crest portion (of the face-splines)
Y: boundary between the first region and the second region

What is claimed is:

1. A vehicular wheel bearing (100) for rotatably mounting and supporting a vehicle wheel to a vehicle body, comprising:
a wheel hub (200) to which the vehicle wheel is mounted and which rotates together with the vehicle wheel;
at least one inner ring (300) mounted to the wheel hub (200);
an outer ring (400) fixedly coupled to a vehicle-body-side member; and
a plurality of rolling elements (500) configured to rotatably support the wheel hub (200) and the inner rings (300) relative to the outer ring (400),
wherein a face-spline portion (800) is provided on an axially inner end surface of the wheel hub (200) or the inner ring (300) to receive driving power from a constant velocity joint,
wherein the face-spline portion (800) is configured such that tooth crests (810) and tooth roots (820) are alternately and repeatedly arranged along a circumferential direction, and
wherein each tooth crest (810) of the face-spline portion 800 is formed to have a fully rounded shape only in a first region (812) including a highest crest portion X having a maximum crest height.

2. The vehicular wheel bearing according to claim 1, wherein each tooth crest (810) of the face-spline portion (800) is formed in a shape other than a fully rounded shape in a second region (814) positioned radially inward relative to the first region (812).

3. The vehicular wheel bearing according to claim 2, wherein the face-spline portion (800) is formed in a structure in which, as moving radially inward from the highest crest portion X, a height h of the tooth crest (810) decreases and a width w between adjacent tooth roots (820) becomes narrower.

4. The vehicular wheel bearing according to claim 3, wherein in the second region (814), the tooth crest (810) is configured to gradually change from a fully rounded shape to a straight planar shape as moving radially inward.

5. The vehicular wheel bearing according to claim 1, wherein when viewed in a longitudinal cross-section taken along an axial direction, a ridge of the tooth crest (810) of the face-spline portion (800) is formed in a convex curved shape.

6. The vehicular wheel bearing according to claim 1, wherein in the face-spline portion (800), an outer end (832) of a flank surface (830) of each tooth is formed in a convex curved shape.

7. The vehicular wheel bearing according to claim 1, wherein a radially outer end (816) of the face-spline portion (800) is formed in a convex curved surface shape.

8. The vehicular wheel bearing according to claim 1, wherein the face-spline portion (800) is configured to be formed on an axially inner end surface of the wheel hub (200).

9. The vehicular wheel bearing according to claim 8, wherein the inner ring (300) is configured to be fixed on the wheel hub (200) by a forming portion (220) formed by plastically deforming an axially inner end of the wheel hub (200) radially outward, and
wherein the face-spline portion (800) is configured to be formed on an axially inner end surface of the forming portion (220) of the wheel hub (200).

10. The vehicular wheel bearing according to claim 1, the face-spline portion (800) is configured to be formed on an axially inner end surface of the inner ring (300).
